(19) United States
(12) Patent Application Publication
(10) Pub. No.: US 2019/0243669 A1
(43) Pub. Date: Aug. 8, 2019

(54) SKILL DISCOVERY AND BROKERING FRAMEWORK

(71) Applicant: MICROSOFT TECHNOLOGY LICENSING, LLC, Redmond, WA (US)

(72) Inventors: Rahul GUPTA, Hyderabad (IN); Pradeep Kumar REDDY K, Hyderabad (IN); Bhavesh SHARMA, Hyderabad (IN)

(21) Appl. No.: 15/889,066

(22) Filed: Feb. 5, 2018

(51) Int. Cl. G06F 9/451; G10L 15/22; G10L 15/26

(52) U.S. Cl. CPC G06F 9/453; G10L 2015/223; G10L 15/265; G10L 15/22

(57) ABSTRACT

Systems and methods are provided of a digital assistant service for executing user instructions. Indeed, an audio instruction is received by the digital assistant service. The audio instruction comprises audio data of an instruction to be executed on behalf of the submitting user. Moreover, the audio instruction does not explicitly identify a target skill provider for carrying the user's instruction. Upon receiving the audio instruction, a first skill for carrying out the user's instruction is determined. A user record of the user is accessed, where the user record identifies the user's preferences regarding preferred skill providers corresponding to a plurality of skills. A skill provider corresponding to the first skill according to the user record is identified, and the first skill is executed via the identified skill provider on behalf of the user.

### BACKGROUND

Digital assistants, such as Cortana® or Siri®, are online services designed to provide personal assistance to a person/user. These, and other digital assistants, interact with users by way of natural language, i.e., voice commands, to carry out various tasks according to the vocalized, voice commands.

Some implementations of digital assistants are closed systems. In a closed system, the abilities of the digital assistants are limited to those skills that are made available by the digital assistant provider. Skills made available by the digital assistant provider are said to be deeply integrated with the digital assistant. While many deeply integrated skills are, in fact, skills provided by the digital assistant provider, in some cases third-party skills may also be made available through the digital assistant through deep integration (in cooperation with the digital assistant provider.) As such, deeply integrated skills correspond to those that involve integration by or in conjunction the digital assistant provider as a tightly coupled service. It follows, then, that in a closed system, a user can issue any instruction/command to the digital assistant, but only those instructions corresponding to skills deeply integrated in the digital assistant can be completed. Simply put, in a closed system, the user is limited to those skills made available by the provider: i.e., deeply integrated skills.

Other implementations of digital assistants provide both a “standard” set of skills (i.e., skills that are deeply integrated in the digital assistant), and also allow integration of third-party skills. These third-party skills are said to be loosely coupled, not involving deep integration by the digital assistant provider. However, to access these “other,” loosely coupled third-party skills, the user must explicitly identify the target skill as part of the command/instruction. For example, if a computer user were to say to a digital assistant of this type, “Hey, DigitalAssistant, add ‘prepare tax documents’ to my to-do list for this Saturday,” the digital assistant would add the task of “prepare tax documents” to the standard/default to-do list, i.e., the deeply integrated to-do list made available by the digital assistant provider. On the other hand, if that user didn't like the “standard” to-do list, preferring a third-party to-do list service, “Any.Do,” and assuming that this third-party to-do list has been integrated with the digital assistant, the user must include specific instructions to get the task completed by the desired service. For example, to access the Any.Do to-do list, the user must say to the digital assistant: “Hey, DigitalAssistant, add ‘prepare tax documents’ to my Any.Do to-do list for this Saturday.” While these digital assistants provided access to non-integrated services (i.e., not deeply integrated with the digital assistant service), access to the non-integrated skills required the user to be more explicit. Moreover, for any occasion that the user failed to be explicit as to which service/skill provider was intended, the user's instruction would be implemented by the default, integrated skill, likely resulting in a great deal of confusion, loss of data, or any number of undesirable results.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

According to aspects of the disclosed subject matter, systems and methods are provided of a digital assistant service for executing user instructions. Indeed, an audio instruction is received by the digital assistant service. The audio instruction comprises audio data of an instruction to be executed on behalf of the submitting user. Moreover, the audio instruction does not explicitly identify a target skill provider for carrying the user's instruction. Upon receiving the audio instruction, a first skill for carrying out the user's instruction is determined. A user record of the user is accessed, where the user record identifies the user's preferences regarding preferred skill providers corresponding to a plurality of skills. A skill provider corresponding to the first skill according to the user record is identified, and the first skill is executed via the identified skill provider on behalf of the user.

In one embodiment of the disclosed subject matter, a method for executing an instruction on behalf of a user, as implemented by a digital assistant service, is provided. An audio instruction is received. The audio instruction comprises audio data including the user's instruction to be executed on behalf of the user, wherein the user instruction does not explicitly identify a target skill provider for carrying the user's instruction. A first skill for carrying out the user's instruction is determined. A user record of the user is accessed, where the user record identifies the user's preferences regarding preferred skill providers corresponding to a plurality of skills. A skill provider corresponding to the first skill according to the user record is identified and the first skill is executed, via the identified skill provider, on behalf of the user.

According to additional embodiments of the disclose subject matter, a computer system for providing a digital assistant service is presented. The computer system comprises, at least, a processor and a memory, where the processor executes instructions as part of or in conjunction with additional components to respond execute audio instructions on behalf of a user. These additional components include an audio processor, an instruction interpreter, and a skill executor. In execution, the audio processor receives an audio instruction from a user. The audio instruction comprises audio data of a user instruction to be executed on behalf of the user. Moreover, the audio instruction does not explicitly identify a target skill provider for carrying the instruction. The instruction interpreter, in execution on the computer system, determines a first skill for carrying out the user's instruction. The skill executor, in execution on the computer system, accesses a user record of the user that identifies the user's preferences regarding preferred skill providers corresponding to a plurality of skills. Additionally, the skill executor identifies a skill provider corresponding to the first skill according to the user record, and executes the first skill via the identified skill provider on behalf of the user.

According to further embodiments of the disclose subject matter, computer-readable media bearing computer-executable instructions are presented. The computer-executable instructions, when executed on a computer system comprising at least a processor, carry out a method of a digital assistant service provider for executing an instruction on behalf of a user. This method includes maintaining a user records data store, where the user records data store stores user records corresponding to a plurality of users, including the user. Each user record includes user preferences regarding preferred skill providers for the corresponding user. An audio instruction is received from the user. The audio instruction comprising audio data including a user instruction to be executed on behalf of the user. Moreover, the audio instruction does not explicitly identify a target skill provider for carrying the user's instruction. A first skill for carrying out the user's instruction is determined. A user record corresponding to the user is retrieved or accessed from the user records data store. A skill provider corresponding to the first skill according to the user record is identified and the first skill is caused to be executed via the identified skill provider on behalf of the user.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a block diagram of an exemplary network environment suitable for implementing aspects of the disclosed subject matter;

FIG. 2 is a block diagram illustration an exemplary skill table in accordance with aspects of the disclosed subject matter;

FIG. 3 is a flow diagram illustrating an exemplary instruction execution routine carried out by a digital assistant in accordance with aspects of the disclosed subject matter;

FIG. 4 is a flow diagram illustrating an exemplary routine for updating a user's skill provider selection and/or preferences according to usage logs of the corresponding user;

FIG. 5 is a block diagram illustrating an exemplary computer readable medium bearing computer-executable instruction that, in execution, implement aspects of the disclosed subject matter, particularly in regard to instruction execution by a digital assistant; and

FIG. 6 is a block diagram illustrating an exemplary computing system configured to provide digital assistant services according to aspects of the disclosed subject matter.

### DETAILED DESCRIPTION

As indicated above, existing digital assistant solutions have several drawbacks. Closed systems are not scalable: expanding the capabilities/available skills of a closed digital assistant with new skills requires deep integration. Such deep integration requires a substantial investment of time and effort. The digital assistant provider cannot keep up with new functions, features, and opportunities when deep integration is required. Obviously, a closed digital assistant has a restricted breadth of offerings: typically, one offered skill for a given task category.

On the other hand, digital assistant providers that enable third parties to integrate their skills/services in their digital assistant overcome the matter of scalability, but at the expense of user functionality. In short, the user must be very explicit in instructing the digital assistant such that the correct/desired skill is utilized.

According to aspects of the disclosed subject matter, a digital assistant service is presented, where the digital assistant is based on a framework that is open to the integration of third-party task completion services, and simplifies the user interaction according to user preferences (implicit and explicit) and activity logs. Indeed, the disclosed digital assistant service is both scalable and dispenses with explicit directives in the case of typical user request.

Advantageously and according to embodiments of the disclosed subject matter, the digital assistant service utilizes a skill discovery and brokering framework that enables using both deeply integrated skills as well as third-party skills without the need to explicitly identify a specific skill in an instruction in those circumstances where the skill corresponds to a user preference.

For purposes of clarity and definition, the term “exemplary,” as used in this document, should be interpreted as serving as an illustration or example of something, and it should not be interpreted as an ideal or leading illustration of that thing. Stylistically, when a word or term is followed by “(s)”, the meaning should be interpreted as indicating the singular or the plural form of the word or term, depending on whether there is one instance of the term/item or whether there is one or multiple instances of the term/item. For example, the term “user(s)” should be interpreted as one or more users. Moreover, the use of the combination “and/or” with regard to multiple items should be viewed as meaning either or both items.

As indicated above, as used herein a digital assistant corresponds to an online service designed to provide personal assistance to a person/user by executing skills in response to a user instruction or command. Typically, though not exclusively, a digital assistant will comprise a user-interactive process and a back-end process. The user-interactive process receives user instructions and/or commands by way of natural language interaction. The voiced instructions are captured as an audio file and transmitted to the back-end process. As will be described in greater detail below, at the back-end process of the digital assistant, the voiced instruction is converted into a textual representation, and the command (or commands) of the instruction are identified and mapped into one or more skills. In the event that there is no explicitly identified skill in the instruction, a skill is selected according to user preferences.

By way of definition, a user instruction (or command) to a digital assistant corresponds to a direction to carry out a particular, desired function. A user instruction comprises one or more skills to be completed in order to carry out the desired function. A skill corresponds to an action or activity that is carried out by an online service on behalf of the user. For example, adding an item to a to-do list is a skill, which is carried out by an online service according to skill data that defines the specifics of interacting with the online service to add the item to the to-do list of the user. According to aspects of the disclosed subject matter, a desired function may require a specific order to the one or more skills to be completed.

According to embodiments of the disclosed subject matter, as an open system a suitably configured digital assistant may be associated with multiple providers of any given skill. Stated differently, when the digital assistant is instructed to carry out a skill, the digital assistant may need to select among a plurality of skill providers. A skill provider is an online service provider that is able to carry out one or more particular skills.

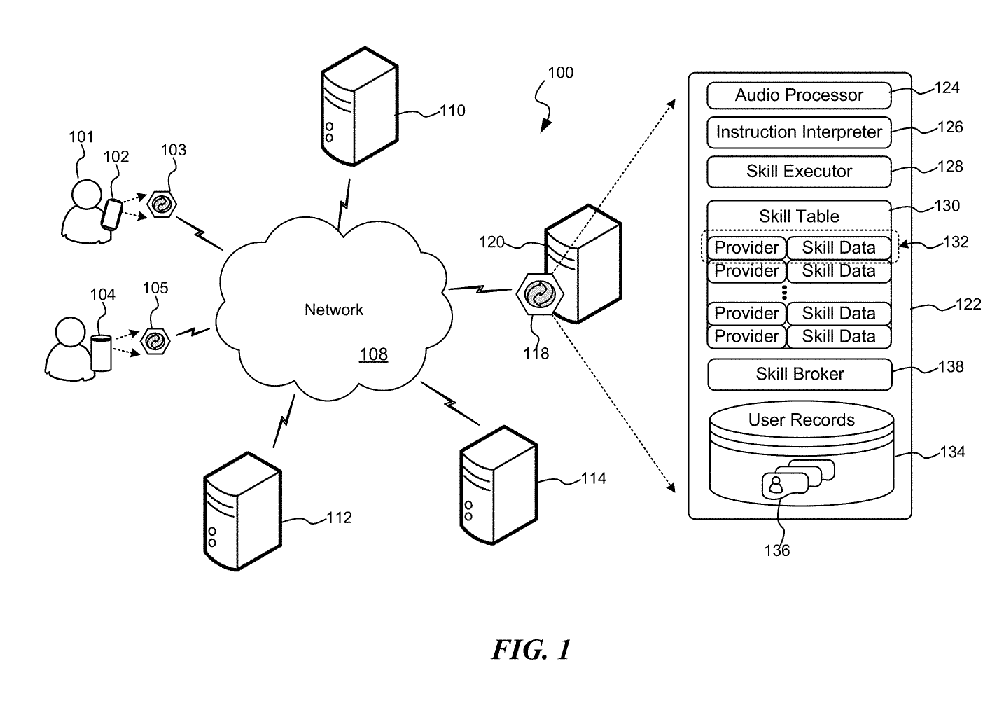

To better describe and illustrate aspects and embodiments of the disclosed subject matter, reference is now made to the figures. Indeed, turning to FIG. 1, this figure is a block diagram of an exemplary network environment 100 suitable for implementing aspects of the disclosed subject matter, particularly in regard to a digital assistant supported by a skill discovery and brokering framework as described herein. The network environment 100 includes one or more user devices, such as user devices 102 and 104, upon which a user-facing process of a digital assistant may operate. As illustrated, user device 102 (corresponding to a mobile phone) includes user-facing process 103, and user device 104 (corresponding to a digital assistant device) include user-facing process 105. These user-facing processes interact over a communication network 108 with a back-end digital assistant process 118 executing on a computing system 120.

Suitable user devices for hosting a user-facing digital assistant process include, by way of illustration and not limitation, mobile phone devices (such as mobile phone 102), digital assistant devices (such as digital assistant device 104), tablet computing devices, laptop computers, desktop computers, smartwatches, and the like. Each of these user devices is configured with audio capture components (e.g., a microphone and supporting structure to capture/record audio content), and network communication components (such as a network interface device).

Also shown in the exemplary network environment 100 are several skill providers associated with the digital assistant process 118, such as skill providers 110-114. With regard to these and other skill providers, third-party skill providers may be associated with a digital assistant process through various engagements, primarily including negotiations with the provider of the digital assistant process to provide skills, as well as third-party skill providers that wish to provide skills that subscribe through a type of application programming interface (API) that allows a skill provider to be associated with a particular skill defined within an ontology of supported/recognized skills. According to information maintained by the back-end digital assistant process 118, the digital assistant communicates with the various skill providers to carry out one or more skills as requested by a user. The digital assistant “executes” the skills, via the skill providers, according to information maintained by the back-end digital assistant process 118.

As mentioned above, the back-end digital assistant process includes a skill discovery and brokering framework 122 that is used to provide an open digital assistant according to aspects of the disclosed subject matter. The framework 122 includes an executable audio processor 124 to convert the natural language instruction of a user to a textual translation. As those skilled in the art will appreciate, converting audio data into text is a known process. In one embodiment, the audio processor 124 relies upon an online service, such as Bing's audio processing service, to convert the audio instruction/command to corresponding textual data.

An executable instruction interpreter 126 takes the textual representation of the audio instruction and identifies the intent of the instruction, and further identifies one or more skills needed to carry out the instruction/command. Determining the intent (i.e., desired action) of the instruction may be carried out according any one or more of semantic analysis of the textual content, structural and grammatic analysis of the textual content, command/verb dictionaries, and the like. The result of execution of the instruction interpreter 126 is a set of one or more skills along with values and data relating to the one or more skills.

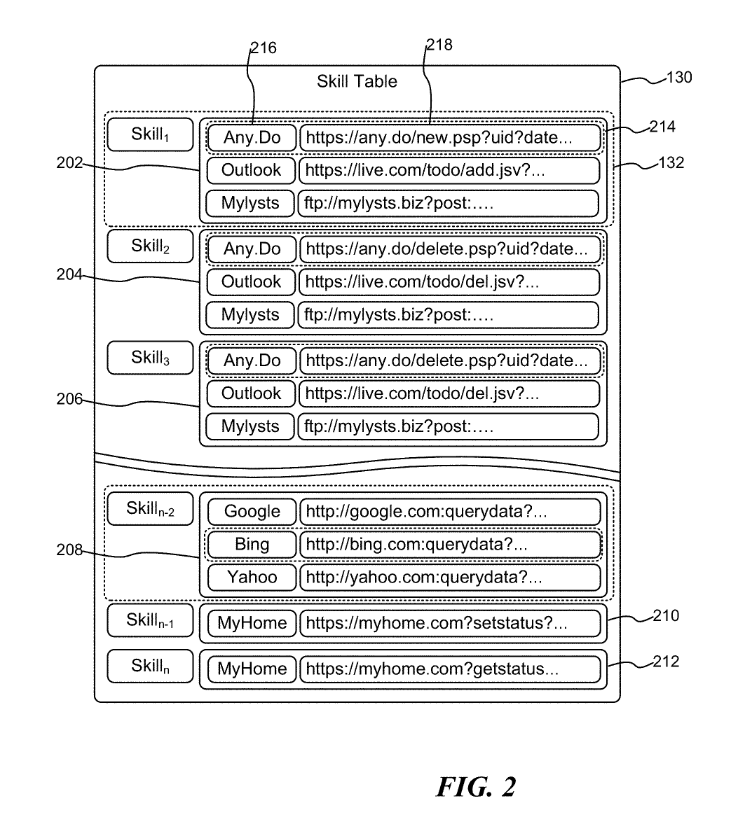

According to various embodiments, an executable skill executor 128 takes the skills and values/data from the instruction interpreter 126 and executes them according to information in a skill table 130. Indeed, the skill executor 128 looks up the various options (skill providers) for carrying out the one or more skills according to skill provider information stored in the skill table. In regard to the skill table 130, FIG. 2 is a block diagram illustrating an exemplary skill table 130 suitable for associating skill providers (with corresponding skill data for executing a skill with a corresponding skill provider) with skills that may be implemented by a digital assistant process 118. In this illustrated embodiment, the skill table comprises a plurality skill records 202-212, where each record comprises one or more tuples of data, with each tuple identifying a skill provider and skill data, such tuple 214 comprising a skill provider field 216 identifying the provider and skill data field 218 describing skill data for carrying out a corresponding skill with the skill provider.

As can be seen in FIG. 2, each skill record may be associated with one or more skill providers. For example, skill record 202 is shown as being associated with three skill providers (i.e., three skill providers that are able and registered to provide the corresponding skill for the user), while skill records 210 ad 212 are shown as being associated with a single skill provider. While not specifically identified in FIG. 2, each skill record has some mechanism for identifying the user-preferred skill provider. In various embodiments, the first identified skill provider (skill record) may be considered the user-preferred skill provider. Additionally, if there is only one skill provider associated with any given skill, such as with Skillₙ associated with skill record 212, the identified skill provider is assumed to be the user-preferred, default skill provider. Alternatively, an indicator within a skill record may identify the user-preferred skill provider. As shown in FIG. 2, skill record 214 is identified as having a dashed line around the record indicating that this is the user-preferred skill provider for Skill₁.

It should be appreciated that while the skill table 130 could be implemented as a table/array of records identifying the skill providers that may be utilized to carry out a corresponding skill, and perhaps stored in some manner that the information is indexed according to the ordinal value of the skill, the skill provider, and the like, it is simply one, non-limiting embodiment. In alternative embodiments, a “skill table” may be implemented as a database of records (indexed or not) in which the records are associated with a particular skill and identify who and how a skill is implemented by the digital assistant process 118. Irrespective of implementation specific details, a skill table permits the identification of a user-preferred skill providers with regard to a particular skill, and further indicates how the skill provider is engaged to carry out the particular skill. According to aspects of the disclosed subject matter, in conjunction with user preferences stored a corresponding user record (such as user record 136), the skill executor identifies a skill provider according to the information in the skill table 130, organizes a call to the identified skill provider according to associated skill data, and “executes” the skill by making the call to the identified skill provider, such as skill provider 216.

Returning again to FIG. 1, the framework 122 further includes an executable skill broker 128 that, in execution, analyzes a user's “usage data” that includes, by way of illustration and not limitation, prior application, app, and/or service usage, current preferences, and the like, to implicitly identify user-specific “default” skill providers within the skill table 130. By way of definition, an “application” corresponds to a set of computer-executable code designed to carry out one or more functions on behalf of a computer user, and typically carry out these functions at the direction of the computer user. An “app” is an application (i.e., computer-executable set of code) that is typically narrower in focus that an “application” and substantially smaller. Typically, though not exclusively, an app is downloaded over a network onto and for execution on a mobile computing device, such as a smart phone. Regarding the user-specific default skill providers and by way of example, based on information (the user's usage data) regarding frequent use of the Any.do to-do list service, the skill broker 138 may determine that this service, Any.do to list, should be the default to-do skill provider for the user. Of course and as suggested above, other bases of usage data for determining the appropriate skill provider for a user may include recent downloads and/or recent use of a particular service, historical use of an app/application/service, corporate policies regarding which skill providers may be used, typically though not exclusively determined in conjunction with contextual or work related information (e.g., time of day, day of week, location), and the like may all be considered by the skill broker 138, through various heuristics, in determining which skill provider to use for a particular task. This default determination, based on a variety of factors, means that when the computer user does not specify a specific skill provider in an instruction, an appropriate default skill provider will still be used.

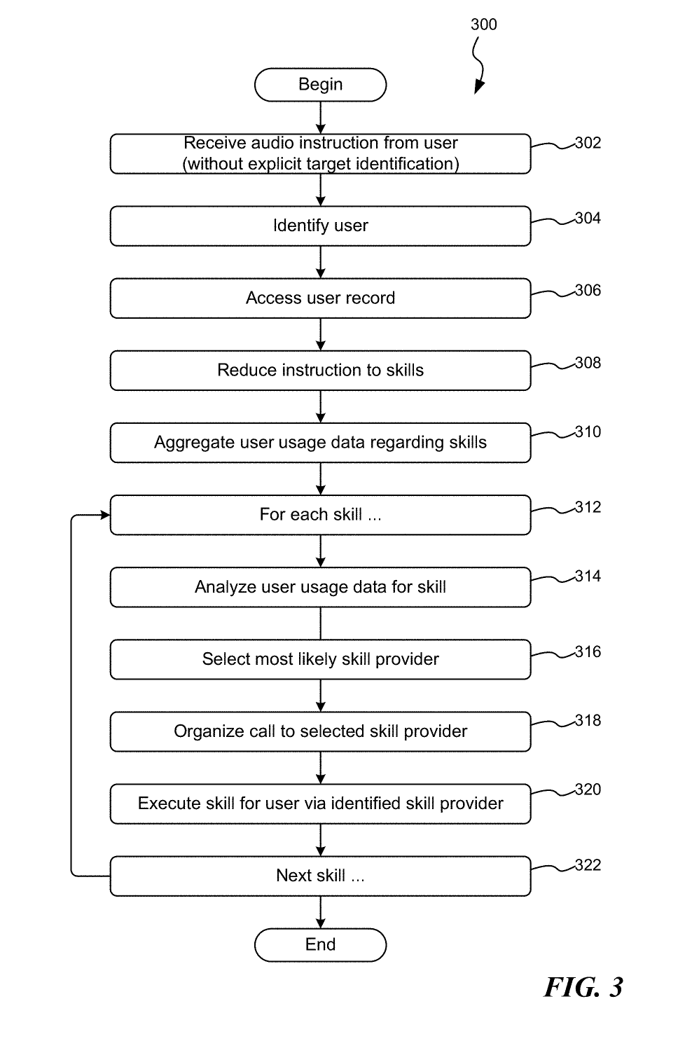

Regarding the processing of a user instruction, FIG. 3 is a flow diagram illustrating an exemplary instruction execution routine 300 carried out by a digital assistant (in particular, a back-end digital assistant process) in accordance with aspects of the disclosed subject matter. The routine begins at block 302 where the digital assistant (comprising both a user-facing process and a back-end process) receives a user instruction/command. This instruction, typically received at the user-facing digital assistant process (e.g., user-facing digital assistant process 103), is transferred over a communication network 108 to the back-end digital assistant process 118.

At block 304, the user issuing the instruction is identified. This identification is typically made as a result of information provided from the user-facing digital assistant process 103 to the back-end digital assistant process 118. This information may include, by way of illustration but not limitation, a globally unique user identifier (e.g., an identification number), globally unique user identification (e.g., an email address), or a computer network address (e.g., an IP address) associated with a particular user. After identifying the user, at block 306 a user record (such as user record 136) containing user preferences with regard to skill providers is accessed.

At block 308, the user instruction is reduced to a set of one or more skills with corresponding values. As discussed above, reducing the user instruction to one or more skills includes, in various embodiments, converting the audio of the user instruction to a textual representation, identifying the intent (or intents) of the user instruction, and identifying the set of one or more skills (with corresponding values and data) that, collectively, will carry out the user's intent or intents of the instruction. Of course, it should be appreciated that converting the audio data of the user instruction to a textual representation is simply one path to identifying the set of skills to execute. In various alternative embodiments, one or more analyses of the audio instruction may be made to directly identify the intent and corresponding skills to carry out that intent (or intents), without reducing the audio instruction to a textual representation.

At block 310, usage data of the user that relates to the one or more skills is aggregated. For example, usage data of the user regarding a recent download of and interaction with of an app may be aggregated with historical information regarding prior app usage, as well as information regarding current contextual factors (time of day, day of week, etc., and applicable corporate policies.

With the set of skills and corresponding usage data identified, at block 312 an iteration loop is begun to iterate through each of the identified skills for execution. At block 314, an analysis of the aggregated usage data corresponding and/or relating to the currently iterated skill is analyzed by the skill broker 138. This analysis includes evaluating what skill providers are available for processing this skill, past default skill providers used in conjunction with the currently iterated skill as well as past usage volume, recent installations and/or usage of skill providers offering the currently iterated skill, current contextual information of the user as well as any particular policies that are in place regarding app/application/service usage. This analysis may further consider any explicit identification by the user of a default skill provider for the currently iterated task. The result of the analysis is a type of score indicating, for each of the various skill providers associated with the currently iterated skill, a likelihood that the corresponding skill provider is the skill provider that the user would want to complete the skill. Based on the analysis, at block 316, the most likely skill provider (having the most favorable/likely score) is selected as the current default skill provider for the currently iterated skill.

According to aspects of the disclosed subject matter and as suggested in the skill table 130, each entry or record in the skill table includes a tuple or skill record, such as skill record 132, comprising at least a skill provider 216 and skill data 218 identifying the manner in which the skill provider is to be contacted for executing the currently iterated skill. Thus, at block 318, the call to the selected skill provider is organized according to the skill data associated with the selected skill provider for the currently iterated skill.

At block 320, the currently iterated skill is executed via the identified skill provider. Thereafter, at block 322, a determination is made as part of the iteration loop, the determination as to whether there are additional skills to be processed or not. If there are additional skills to process, the routine 300 returns to block 312, where the next skill is identified for processing as described above. Alternatively, if there are no more skills to process, the routine 300 terminates.

As suggested above, one of the advantages of the disclosed subject matter is to be able to identify a skill provider for a skill as a function of usage data (as described above), irrespective of whether the particular skill provider is deeply integrated with the digital assistant provider. As set forth in routine 300, the identification of a likely skill provider for a given skill may be made dynamically according to usage logs (corresponding to a particular user) of applications, apps, services, contextual information, and the like, as well as other user preferences that may lead to implicitly identify preferred skill providers for a set of skills.

While routine 300 is described in regard to an ontology of skills (i.e., a known set of skills that carry out one or more specific tasks), it should be appreciated that a skill provider may offer skills that are not necessarily defined by the ontology, or that vary in result from the defined skills of the ontology. According to aspects of the disclosed subject matter, such situations may be handled in a variety of ways. In one instance, for the skill provider that wishes to offer skills that are not currently part of a defined ontology, that skill provider may (though an API or similar interface) provide information regarding the unsupported skill. Indeed, that skill provider may act as an extension to the skill broker 138 in identifying the skill (or skills) that the user may have issued. In this regard, when a user issues an instruction that is not recognized by the skill broker 138, that instruction may be handed off to a skill broker provided by the third party to determine whether the user instruction is a “known” instruction as well as information for the skill executor 132 regarding “how” to carry out the user's instruction. As an alternative embodiment, the skill provider may provide information to the skill broker in regard to how to recognize a user instruction that includes the new skill and add information to the skill table that will enable the skill executor 128 to carry out the user's instruction. Accordingly, it should be appreciated that disclosed subject matter may be advantageously implemented in environments in which a digital assistant process does not operate according to a fixed skill ontology.

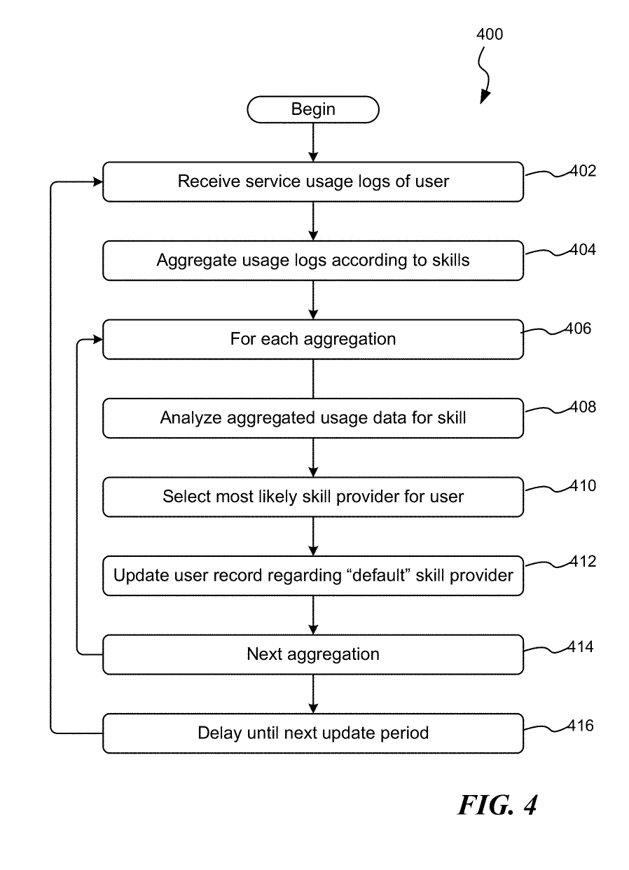

In an alternative embodiment to a dynamic determination of likely skill providers (as described in routine 300), and according to aspects of the disclosed subject matter, an ongoing analysis of a user's usage data may be conducted in order to update or maintain a user's preferences with regard to skill providers. FIG. 4 is a flow diagram illustrating an exemplary routine 400 for updating a user's skill provider selection and/or preferences according to usage logs of the corresponding user.

Beginning at block 402, the exemplary routine 400 (as may be implemented by the skill broker 138 of the skill and brokering framework 122) receives or otherwise accesses usage logs of a user. As suggested above, these usage logs may correspond to actual usage of skill provider services as evidenced by application, app and/or service usage, recent usage and/or recent access or downloading of apps and applications, contextual information, and the like. Further still, information regarding a user's preferences (e.g., with regard to a preferred provider of services generally, existing accounts with various providers, current default skill providers, etc.) may be accessed in order to identify and/or infer preferred skill providers for a given skill.

At block 404, the usage logs and preference information are aggregated according to skills, such that user-specific default preferences regarding each particular skill may be identified. According to aspects of the disclosed subject matter, the digital assistant provider maintains an ontology of skills, this ontology identifying those skills that the digital assistant recognizes, as well as identifying information that is needed and/or optional in carrying out a skill by way of skill provider. Typically, though not exclusively, this information further includes how the corresponding skill provider is contacted (as suggested in block 314 of routine 300.) Alternatively, information regarding specific integration matters of the third-party skill provider with the digital assistant service may be incorporated within an application programming interface (API) that may be used to registered with the service.

At block 406, an iteration loop is begun to iterate through each aggregation of information. Thus, at block 408, an analysis of the usage data is made. As described above in regard to block 314 of routine 300, this analysis includes evaluating which skill providers are available for processing this skill, execution costs associated with skill providers, quality and reputation of skill providers, past default skill providers used in conjunction with the currently iterated skill as well as past usage volume, recent installations and/or usage of skill providers offering the currently iterated skill, current contextual information of the user as well as any particular policies that are in place regarding app/application/service usage. This analysis may further consider any explicit identification by the user of a default skill provider for the currently iterated task. The result of the analysis is a type of score indicating, for each of the various skill providers associated with the currently iterated skill, a likelihood that the corresponding skill provider is the skill provider that the user would want to complete the skill. According to various embodiments, the result of the analysis is a score associated with each of the skill providers.

At block 410, a selection is made of the most likely skill provider of the current skill for the user. This selection is made according to the various scores associated with the various skill providers for the currently skill. In one embodiment, a new likely skill provider is made, in the stead of a current, default skill provider, only when the score of a “winning” skill provider meets or exceeds a predetermined threshold.

Based on this determination, at block 412 the skill provider associated with the skill of the currently iterated aggregation is updated in the user record as the “winning” skill provider (i.e., that skill provider having the best score.) Thereafter, or if the user record is not to updated with a new skill provider, the routine 400 proceeds to block 414.

At block 414, as part of the iteration loop begun at block 406, a determination is made as to whether there are additional aggregations to process. If so, the routine 400 returns to block 406 for additional processing. However, when there are no more aggregations to process, the routine 400 proceeds to block 416. At block 416, the exemplary routine 400 delays until a new update period is reached, whereupon the routine 400 returns to block 402 and repeats the process as described above.

Regarding routines 300 and 400 described above, as well as other processes that may be described herein, while these routines/processes are expressed in regard to discrete steps, these steps should be viewed as being logical in nature and may or may not correspond to any specific actual and/or discrete execution steps of a given implementation. Also, the order in which these steps are presented in the various routines and processes, unless otherwise indicated, should not be construed as the only order in which the steps may be carried out. Moreover, in some instances, some of these steps may be combined and/or omitted. Those skilled in the art will recognize that the logical presentation of steps is sufficiently instructive to carry out aspects of the claimed subject matter irrespective of any particular development or coding language in which the logical instructions/steps are encoded.

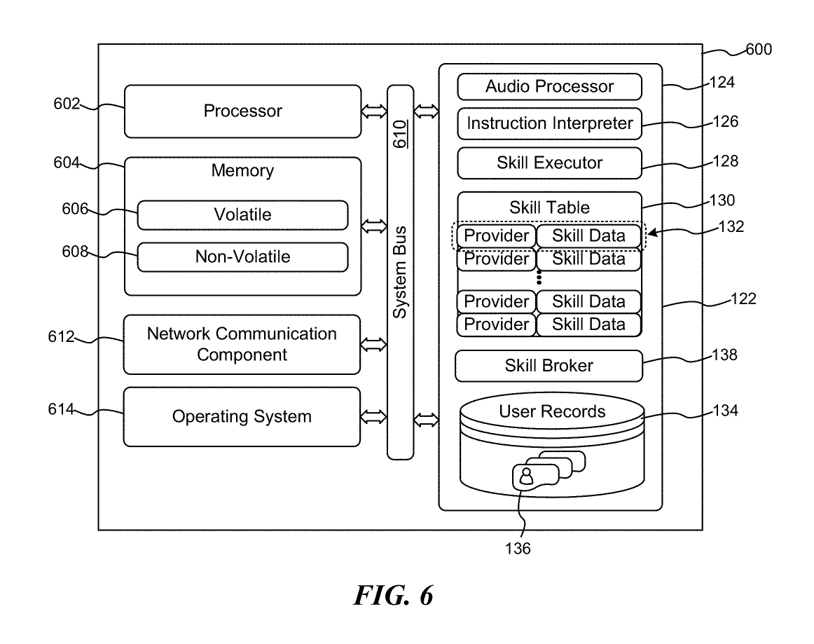

Of course, while the routines and/or processes include various novel features of the disclosed subject matter, other steps (not listed) that support key elements of the disclose subject matter set forth in the routines/processes may also be included and carried out in the execution of these routines. Those skilled in the art will appreciate that the logical steps of these routines may be combined together or be comprised of multiple steps. Steps of the above-described routines may be carried out in parallel or in series. Often, but not exclusively, the functionality of the various routines is embodied in software (e.g., applications, system services, libraries, and the like) that is executed on one or more processors of computing devices, such as the computing device described in regard FIG. 6 below. Additionally, in various embodiments all or some of the various routines may also be embodied in executable hardware modules including, but not limited to, system on chips (SoC's), codecs, specially designed processors and or logic circuits, and the like on a computer system.

As suggested above, these routines and/or processes are typically embodied within executable code blocks and/or modules comprising routines, functions, looping structures, selectors and switches such as if-then and if-then-else statements, assignments, arithmetic computations, and the like that, in execution, configure a computing device to operate in accordance with these routines/processes. However, the exact implementation in executable statement of each of the routines is based on various implementation configurations and decisions, including programming languages, compilers, target processors, operating environments, and the linking or binding operation. Those skilled in the art will readily appreciate that the logical steps identified in these routines may be implemented in any number of ways and, thus, the logical descriptions set forth above are sufficiently enabling to achieve similar results.

While many novel aspects of the disclosed subject matter are expressed in routines embodied within applications (also referred to as computer programs), apps (small, generally single or narrow purposed applications), and/or methods, these aspects may also be embodied as computer executable instructions stored by computer readable media, also referred to as computer readable storage media, which are articles of manufacture. As those skilled in the art will recognize, computer readable media can host, store and/or reproduce computer executable instructions and data for later retrieval and/or execution. When the computer executable instructions that are hosted or stored on the computer readable storage devices are executed by a processor of a computing device, the execution thereof causes, configures and/or adapts the executing computing device to carry out various steps, methods and/or functionality, including those steps, methods, and routines described above in regard to the various illustrated routines and/or processes. Examples of computer readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random-access memory (RAM), read-only memory (ROM), memory cards, thumb drives, and the like; cloud storage (i.e., an online storage service); and the like. While computer readable media may reproduce and/or cause to deliver the computer-executable instructions and data to a computing device for execution by one or more processors via various transmission means and mediums, including carrier waves and/or propagated signals, for purposes of this disclosure computer readable media expressly excludes carrier waves and/or propagated signals.

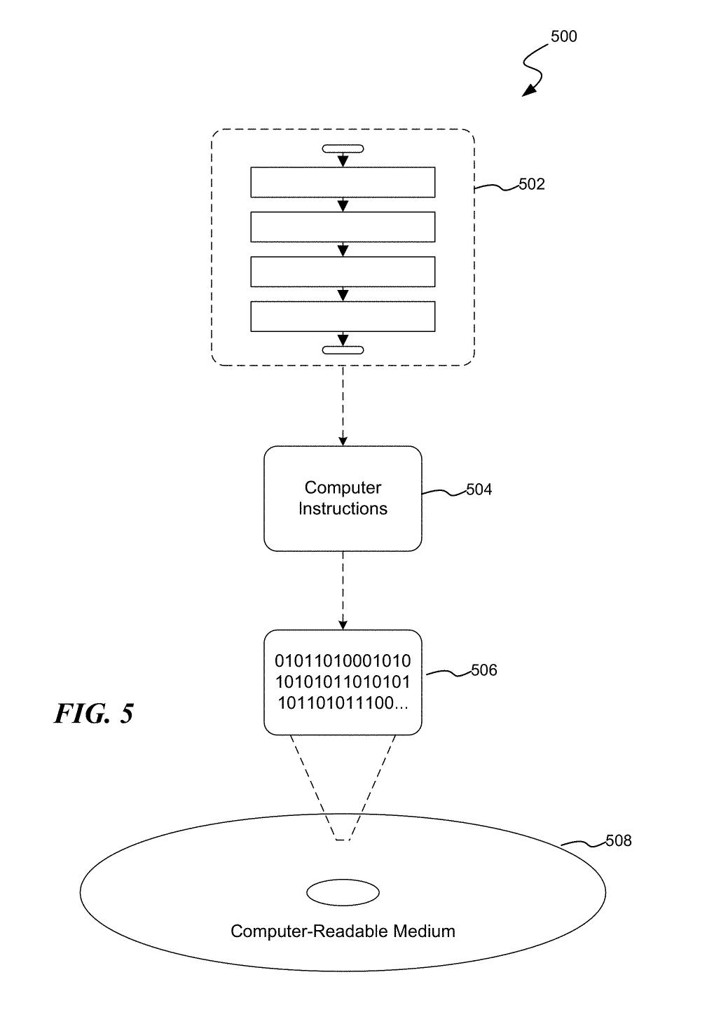

Regarding computer readable media, FIG. 5 is a block diagram illustrating an exemplary computer readable medium encoded with instructions illustrating an exemplary computer readable medium bearing computer-executable instruction that, in execution, implement aspects of the disclosed subject matter, particularly in regard to instruction execution by a digital assistant. More particularly, the implementation 500 comprises a computer-readable medium 408 (e.g., a CD-R, DVD-R or a platter of a hard disk drive), on which is encoded computer-readable data 506. This computer-readable data 406 in turn comprises a set of computer instructions 504 configured to operate according to one or more of the principles set forth herein. In one such embodiment 502, the processor-executable instructions 504 may be configured to perform a method, such as at least some of exemplary method 300, for example. In another such embodiment, the processor-executable instructions 504 may be configured to implement a system on a computing device, such as at least some of the exemplary, executable components of system 600 of FIG. 6, as described below. Many such computer readable media may be devised, by those of ordinary skill in the art, which are configured to operate in accordance with the techniques presented herein.

Turning now to FIG. 6, FIG. 6 is a block diagram illustrating an exemplary computing system configured to provide digital assistant services according to aspects of the disclosed subject matter. A suitably configured hosting computing device, such as computing device 120, may comprise any of a number of computing system including, by way of illustration and not limitation, a desktop computer, a laptop/notebook computer, mini- and mainframe computing devices, network servers, and the like. Generally speaking, irrespective of the particular type of computing system, the computing system 600 typically includes one or more processors (or processing units), such as processor 602, and further includes at least one memory 604. The processor 602 and memory 604, as well as other components of the computing device 500, are interconnected by way of a system bus 610.

As will be appreciated by those skilled in the art, the memory 604 typically (but not always) comprises both volatile memory 606 and non-volatile memory 608. Volatile memory 606 retains or stores information so long as the memory is supplied with power. In contrast, non-volatile memory 608 is capable of storing (or persisting) information even when a power supply is not available. Generally speaking, RAM and CPU cache memory are examples of volatile memory 606 whereas ROM, solid-state memory devices, memory storage devices, and/or memory cards are examples of non-volatile memory 608.

As will also appreciated by those skilled in the art, the processor 602 executes instructions retrieved from the memory 604, from computer-readable media, such as computer-readable media 500 of FIG. 5, and/or other executable components in carrying out various functions of implementing digital assistant services. The processor 602 may be comprised of any of a number of available processors such as single-processor, multi-processor, single-core units, and multi-core units, which are well known in the art.

Further still, the illustrated computing system 600 typically includes a network communication component 612 for interconnecting this computing device with other devices and/or services over a computer network, such as network 108. The network communication component 612, sometimes referred to as a network interface card or NIC, communicates over a network using one or more communication protocols via a physical/tangible (e.g., wired, optical fiber, etc.) connection, a wireless connection such as WiFi or Bluetooth communication protocols, NFC, or a combination thereof. As will be readily appreciated by those skilled in the art, a network communication component, such as network communication component 612, is typically comprised of hardware and/or firmware components (and may also include or comprise executable software components) that transmit and receive digital and/or analog signals over a transmission medium (i.e., the network.)

As discussed above, a suitably configure computing system 600 will further include a skill discovery and brokering framework 122, used to provide digital assistant services according to aspects of the disclosed subject matter. The framework 122 includes an executable audio processor 124 to convert the natural language instruction of a user to a textual translation. As those skilled in the art will appreciate, converting audio data into text is a known process. In one embodiment, the audio processor 124 relies upon an online service, such as Bing's audio processing service, to convert the audio instruction/command to corresponding textual data.

An executable instruction interpreter 126 takes the textual representation of the audio instruction and identifies the intent of the instruction, and further identifies one or more skills needed to carry out the instruction/command. Determining the intent (i.e., desired action) of the instruction may be carried out according any one or more of semantic analysis of the textual content, structural and grammatic analysis of the textual content, command/verb dictionaries, and the like. The result of execution of the instruction interpreter 126 is a set of one or more skills along with values and data relating to the one or more skills.

According to various embodiments, an executable skill executor 128 takes the skills and values/data from the instruction interpreter 126 and executes them according to information in a skill table 130. Indeed, the skill executor 128 looks up the various options (skill providers) for carrying out the one or more skills in the skill table. According to aspects of the disclosed subject matter, in conjunction with user preferences stored a corresponding user record (such as user record 136), the skill executor identifies a skill provider according from the skill table 130, organizes a call to the identified skill provider according to associated skill data, and “executes” the skill by making the call to the identified skill provider, such as skill provider 114.

The framework 122 further includes an executable skill broker 138 that, in execution, analyzes a user's prior application, app, and/or service usage, current preferences, and the like to implicitly identify “default” skills within the skill table. For example, based on information regarding frequent use of the Any.do to-do list service, the skill broker 138 may determine that this service, Any.do to list, should be the default to-do skill provider for the user. This determination means that when the computer user does not specify a specific skill provider in an instruction, the default skill provider will be used.

Regarding the various components of the exemplary computing system 600, those skilled in the art will appreciate that many of these components may be implemented as executable software modules stored in the memory of the computing device, as executable hardware modules and/or components (including SoCs—system on a chip), or a combination of the two. Indeed, components may be implemented according to various executable embodiments including executable software modules that carry out one or more logical elements of the processes described in this document, or as hardware and/or firmware components that include executable logic to carry out the one or more logical elements of the processes described in this document. Examples of these executable hardware components include, by way of illustration and not limitation, ROM (read-only memory) devices, programmable logic array (PLA) devices, PROM (programmable read-only memory) devices, EPROM (erasable PROM) devices, and the like, each of which may be encoded with instructions and/or logic which, in execution, carry out the functions and features described herein.

Moreover, in certain embodiments each of the various components of the exemplary computing system 600 may be implemented as an independent, cooperative process or device, operating in conjunction with or on one or more computer systems and or computing devices. It should be further appreciated, of course, that the various components described above should be viewed as logical components for carrying out the various described functions. As those skilled in the art will readily appreciate, logical components and/or subsystems may or may not correspond directly, in a one-to-one manner, to actual, discrete components. In an actual embodiment, the various components of each computing device may be combined together or distributed across multiple actual components and/or implemented as cooperative processes on a computer network as in known in the art.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method of a digital assistant service provider for executing an instruction on behalf of a user, the method comprising:
receiving an audio instruction, the audio instruction comprising audio data including a user instruction to be executed on behalf of the user, wherein the user instruction does not explicitly identify a target skill provider for carrying out the user's instruction;
determining a first skill for carrying out the user's instruction;
accessing a user record of the user, the user record identifying the user's preferences regarding preferred skill providers corresponding to a plurality of skills;
identifying a preferred skill provider corresponding to the first skill according to the user record; and
executing the first skill via the identified preferred skill provider on behalf of the user.

2. The computer-implemented method of claim 1, wherein the identified preferred skill provider is not a deeply integrated skill provider of the digital assistant service provider.

3. The computer-implemented method of claim 1, further comprising:
translating the audio instruction to a textual representation;
wherein determining the first skill for carrying out the user's instruction comprises determining the first skill for carrying out the user's instruction from the textual representation of the audio instruction.

4. The computer-implemented method of claim 1, wherein the identified preferred skill provider is a remote third-party skill provider to the digital assistant service provider; and
wherein executing the first skill via the identified preferred skill provider on behalf of the user comprises:
configuring a remote call to the identified preferred skill provider to execute the first skill on behalf of the user; and
executing the configured remote call to the identified preferred skill provider over a network.

5. The computer-implemented method of claim 1, further comprising:
determining a plurality of skills for carrying out the user's instruction, including the first skill; and
identifying a preferred skill provider for each of the plurality of skills according to the user record, including the first skill provider with regard to the first skill; and
executing each of the plurality of skills via the identified preferred skill provider on behalf of the user.

6. The computer-implemented method of claim 5, wherein determining the plurality of skills for carrying out the user's instruction includes a determined execution order among the plurality of skills to carry out the user's instruction; and
wherein executing each of the plurality of skills via the identified preferred skill provider on behalf of the user comprises executing each of the plurality of skills via the identified preferred skill provider on behalf of the user according to the determined execution order.

7. The computer-implemented method of claim 1, further comprising:
receiving service usage logs corresponding to the user;
aggregating the usage logs according to the plurality of skills, each aggregation of usage logs corresponding to one of the plurality of skills; and
for each aggregation of usage logs:
analyzing the aggregation of usage logs to determine whether to update the user's preferences with a preferred skill provider for the corresponding skill; and
updating the user's preferences with a preferred skill provider for the corresponding skill.

8. A computer system for providing a digital assistant service, the computer system comprising a processor and a memory, wherein the processor executes instructions as part of or in conjunction with additional components to respond execute audio instructions on behalf of a user, the additional components comprising:
an audio processor that, in execution by the computer system, receives an audio instruction, the audio instruction comprising audio data of an instruction to be executed on behalf of a user, wherein the audio instruction does not explicitly identify a target skill provider for carrying the instruction;
an instruction interpreter that, in execution by the computer system, determines a first skill for carrying out the user's instruction; and
a skill executor that, in execution by the computer system:
accesses a user record of the user, the user record identifying user preferences regarding preferred skill providers corresponding to a plurality of skills;
identifies a skill provider corresponding to the first skill according to the user record; and
executes the first skill via the identified skill provider on behalf of the user.

9. The computer system of claim 8, wherein the instruction interpreter, in execution, further translates the audio instruction to a textual representation; and
wherein the instruction interpreter, in execution, determines the first skill for carrying out the user's instruction from the textual representation of the audio instruction.

10. The computer system of claim 8, wherein the identified skill provider is a remote third-party skill provider to the computer system; and
wherein the skill executor, in execution on the computer system, executes the first skill via the identified skill provider on behalf of the user comprising:
configuring a remote call to the identified skill provider to execute the first skill on behalf of the user; and
executing the configured remote call to the identified skill provider over a network.

11. The computer system of claim 8, wherein the instruction interpreter, in execution on the computer system, determines a plurality of skills for carrying out the user's instruction, including the first skill; and
wherein the skill executor, in execution on the computer system:
identifies a skill provider for each of the plurality of skills according to the user record, including the first skill provider with regard to the first skill; and
executes each of the plurality of skills via the identified skill provider on behalf of the user.

12. The computer system of claim 11, wherein the instruction interpreter, in execution on the computer system:
determines the plurality of skills for carrying out the user's instruction having to a determined execution order among the plurality of skills to carry out the user's instruction; and
executes each of the plurality of skills via the identified skill provider on behalf of the user comprises executing each of the plurality of skills via the identified skill provider on behalf of the user according to the determined execution order.

13. The computer system of claim 8, the additional components comprising a skill broker that, in execution on the computer system:
receives service usage logs corresponding to the user;
aggregates the usage logs according to the plurality of skills, each aggregation of usage logs corresponding to one of the plurality of skills; and
for each aggregation of usage logs:
analyzes the aggregation of usage logs to determine whether to update the user's preferences with a preferred skill provider for the corresponding skill; and
updates the user's preferences with a preferred skill provider for the corresponding skill.

14. The computer system of claim 8, wherein the identified skill provider is not a deeply integrated skill provider of the digital assistant service.

15. A computer-readable medium bearing computer-executable instructions which, when executed on a computer system comprising at least a processor, carry out a method of a digital assistant service provider for executing an instruction on behalf of a user, the method comprising:
maintaining a user records data store, the user records data store storing user records corresponding to a plurality of users, including the user, and wherein each user record includes user preferences regarding preferred skill providers for the corresponding user;
receiving an audio instruction from the user, the audio instruction comprising audio data including a user instruction to be executed on behalf of the user, wherein the audio instruction does not explicitly identify a target skill provider for carrying the user's instruction;
determining a first skill for carrying out the user's instruction;
accessing a user record of the user from the user records data store;
identifying a skill provider corresponding to the first skill according to the user record; and
executing the first skill via the identified skill provider on behalf of the user.

16. The computer-readable medium of claim 15, the method further comprising:
translating the audio instruction to a textual representation;
wherein determining the first skill for carrying out the user's instruction comprises determining the first skill for carrying out the user's instruction from the textual representation of the audio instruction.

17. The computer-readable medium of claim 16, wherein the identified skill provider is a remote third-party skill provider to the digital assistant service provider; and
wherein executing the first skill via the identified skill provider on behalf of the user comprises:
configuring a remote call to the identified skill provider to execute the first skill on behalf of the user; and
executing the configured remote call to the identified skill provider over a network.

18. The computer-readable medium of claim 15, the method further comprising:
determining a plurality of skills for carrying out the user's instruction, including the first skill; and
identifying a skill provider for each of the plurality of skills according to the user record, including the first skill provider with regard to the first skill; and
executing each of the plurality of skills via the identified skill provider on behalf of the user.

19. The computer-readable medium of claim 18, wherein determining the plurality of skills for carrying out the user's instruction includes a determined execution order among the plurality of skills to carry out the user's instruction; and
wherein executing each of the plurality of skills via the identified skill provider on behalf of the user comprises executing each of the plurality of skills via the identified skill provider on behalf of the user according to the determined execution order.

20. The computer-readable medium of claim 15, wherein the identified skill provider is not a deeply integrated skill provider of the digital assistant service provider.
